(19) United States
(12) Patent Application Publication
(10) Pub. No.: US 2018/0111681 A1
(43) Pub. Date: Apr. 26, 2018

(54) ROTOR DAMPERS

(71) Applicant: Sikorsky Aircraft Corporation, Stratford, CT (US)

(72) Inventors: Joseph J. Andrews, Hamden, CT (US); William A. Welsh, North Haven, CT (US)

(21) Appl. No.: 15/411,187

(22) Filed: Jan. 20, 2017

Related U.S. Application Data
(60) Provisional application No. 62/281,036, filed on Jan. 20, 2016.

(51) Int. Cl. B64C 27/51; B64C 27/00; B64C 27/72

(52) U.S. Cl. CPC B64C 27/51; B64C 27/72; B64C 27/001

(57) ABSTRACT

A damped rotor system includes a rotor blade defining a longitudinal axis opposed leading and trailing edges and having a blade spar. The rotor blade has flexibility in an edgewise direction defined between the leading and trailing edges. A structural damping assembly has an eddy current damper including a damper body that is mounted to the blade spar. The damper body houses a magnetic member movable relative to the damper body. The damper body is of an electrically conductive non-ferromagnetic material such that movement of the magnetic member relative to the damper body induces magnetic eddy currents in the damper body for damping vibrations of the rotor blade in the edgewise direction.

### CROSS-REFERENCE TO RELATED APPLICATIONS

This application claims the benefit of U.S. Provisional Patent Application No. 62/281,036 filed on Jan. 20, 2016, the entire contents of which is incorporated herein by reference.

### STATEMENT REGARDING FEDERALLY SPONSORED RESEARCH OR DEVELOPMENT

This invention was made with government support under Contract No. W911W6-13-2-0003 awarded by the United States Army. The government has certain rights in the invention.

### BACKGROUND OF THE INVENTION

### 1. Field of the Invention

The present disclosure relates to rotorcraft and rotors generally, and more particularly to damping motion and vibration in rotors.

### 2. Description of Related Art

Traditional rotor blades such as used in conventional helicopters and other rotorcraft are subject to vibration. Considerable effort is made to manage the vibrations, typically by dampers near the blade root, where the root is hinged. In certain applications, rigid rotor blades are used to simplify the hub mechanisms. In rotorcraft with coaxial counter-rotating rotors, using rigid rotor systems, e.g., hingeless rotor systems, can allow for positioning the upper rotor disk relatively close to the lower rotor disk. However, because there typically are no lead/lag adjustment mechanisms, rigid rotor systems can exhibit edgewise or in-plane instability in operational regimes where there is high thrust. This can be a limiting factor, for example, limiting design options and operating envelope.

Rotor stability degrades in high thrust maneuvers for stiff in-plane rotors and ground resonance cases for articulated rotors. Weight optimal blade frequencies often fall in the range of edgewise instabilities. High thrust maneuvers, such as high-G pull-ups and flares to hover, increase the likelihood of instability.

Such conventional methods and systems have generally been considered satisfactory for their intended purpose. However, there is still a need in the art for improved rotor damping. The present disclosure provides a solution for this need.

### SUMMARY OF THE INVENTION

A damped rotor system includes a rotor blade defining a longitudinal axis opposed leading and trailing edges and having a blade spar. The rotor blade has flexibility in an edgewise direction defined between the leading and trailing edges. A structural damping assembly has an eddy current damper including a damper body that is mounted to the blade spar. The damper body houses a magnetic member movable relative to the damper body. The damper body is of an electrically conductive non-ferromagnetic material such that movement of the magnetic member relative to the damper body induces magnetic eddy currents in the damper body for damping vibrations of the rotor blade, e.g., in the edgewise direction.

The blade spar can include a mounting end configured to be mounted to a rotor assembly, and an outboard end opposite the mounting end along the longitudinal axis, wherein the damper body is mounted to the blade spar closer to the outboard end than to the mounting end. The damper body can define a damper axis along which the magnetic member moves relative to the damper body, wherein the damper axis extends in a direction from the leading edge to the trailing edge for damping edgewise vibrations in the rotor blade.

The damper body can be mounted to a leading edge portion of the blade spar and to a trailing edge portion of the blade spar opposite the leading edge portion. The magnetic member can be mounted to the damper body by a spring complaint in an edgewise direction of the rotor blade. The magnetic member can be mounted to the damper body by a pair of springs, one on each of opposite sides of the magnetic damper, wherein the springs are aligned and compliant in an edgewise direction of the rotor blade.

The magnetic member can include a non-ferromagnetic non-electrically conductive spool with a rare-earth magnet disposed around the spool. For example, the spool can be made of a light weight composite material. The magnetic member can include a lining of bearing material such as Frelon, or other any other suitable PTFE material, to facilitate relative movement of the magnetic member and the damper body.

The damper body can be of a non-ferrous, conductive material such as aluminum. The damper body can include a tubular wall with the magnetic member inside the tubular wall. The tubular wall can define a cross-sectional shape of at least one of square or circular, or any other suitable shape. The magnetic member can conform to the cross-sectional shape of the tubular wall.

The blade spar can include a mounting end configured to be mounted to a rotor assembly, and an outboard end opposite the mounting end along the longitudinal axis, wherein the damper body is a rotational eddy current damper mounted to the blade spar closer to the mounting end than to the damper end. The eddy current damper can include a pulley wheel and can be mounted to the blade spar through a cable wrapped around the pulley wheel. Opposed ends of the cable can be mounted to respective leading and trailing edge portions of the blade spar so the eddy current damper can dampen edgewise vibrations at the outboard end of the blade spar. The eddy current damper can be mounted to a hub or a hub portion of the rotor blade through a spring member extending axially relative to the longitudinal axis. Any other suitable type of damper can be used in addition to or in lieu of the rotational eddy-current damper.

An aircraft includes a rotor assembly which rotates about an axis and the damped rotor system as above, wherein the rotor blade is mounted to the rotor assembly.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a side elevation view of an exemplary embodiment of a rotorcraft constructed in accordance with an embodiment of the present disclosure, showing rigid rotor blades;

FIG. 2 is a schematic plan view of the one of the rotor blades of FIG. 1, showing an embodiment of the rotor damping system;

FIG. 3 is a schematic plan view of the rotor damping system of FIG. 2, showing the eddy-current magnet, damper body, and springs;

FIG. 4 is a schematic plan view of another exemplary embodiment of a rotor damping system in accordance with an embodiment the present disclosure, showing spar cables for translating tip rotations to the blade root; and

FIG. 5 is a schematic perspective view of an exemplary embodiment of a rotational eddy damper for use with the rotor damper system of FIG. 4.

### DETAILED DESCRIPTION OF THE PREFERRED EMBODIMENTS

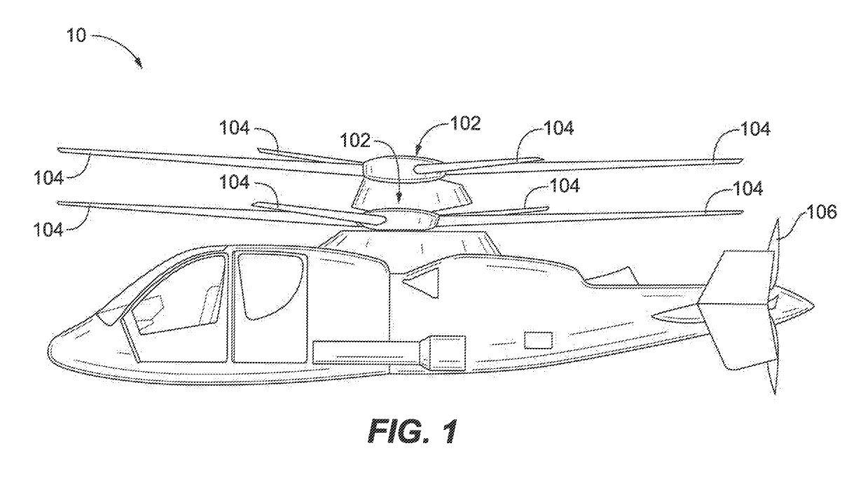

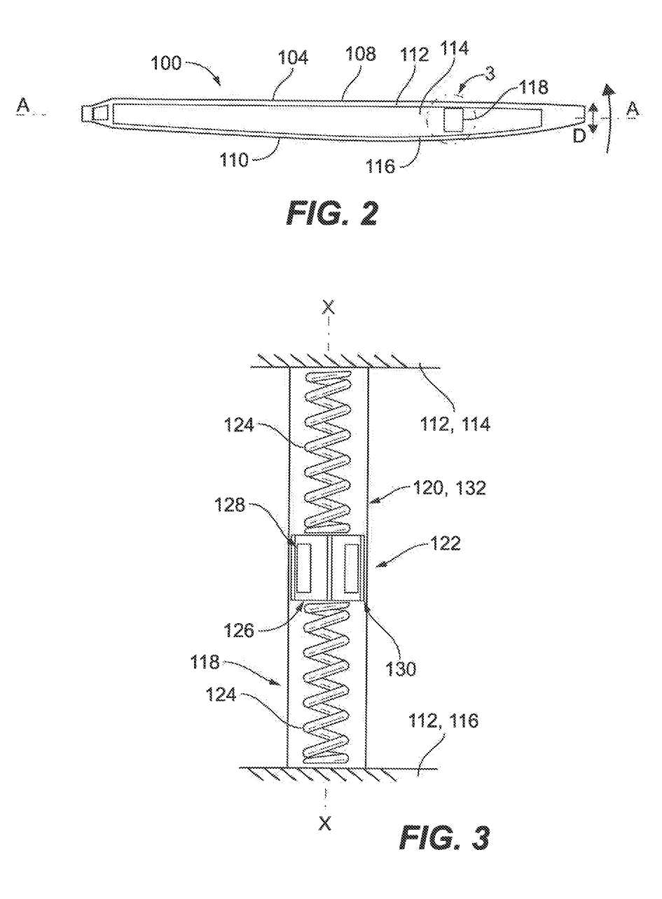

Reference will now be made to the drawings wherein like reference numerals identify similar structural features or aspects of the subject disclosure. For purposes of explanation and illustration, and not limitation, a partial view of an exemplary embodiment of a rotor damping system in accordance with the disclosure is shown in FIG. 2 and is designated generally by reference character 100. Other embodiments of rotor damping systems 100 in accordance with the disclosure, or aspects thereof, are provided in FIGS. 1 and 3-5, as will be described. The systems and methods described herein can be used for rotor damping, for example in rigid rotor blades such as used in rotorcraft with coaxial counter-rotating rotors.

With reference to FIG. 1, rotorcraft 10 includes two coaxial counter-rotating rotors 102, each having four rigid rotor blades 104. Rotorcraft 10 also includes a propulsor rotor 106. Those skilled in the art will readily appreciate that rotorcraft 10 is provided as an example, and that any other suitable type of rotorcraft can be used with the systems and methods disclosed herein without departing from the scope of this disclosure. Additionally, while described herein in the exemplary context of rigid rotor blades of the main rotors, those skilled in the art will readily appreciate that the systems and methods disclosed herein can be used on any suitable type of rotor blades including articulated rotor blades, non-rigid rotor blades, tail blades, aircraft and maritime propellers, wind turbine blades, and blades used on other types of rotary aircraft. Rotorcraft 10, or any other suitable type of aircraft, can include a rotor assembly and the rotor damping system as described herein, wherein the rotor blade, e.g., rotor bade 104, is mounted to the rotor assembly, e.g., rotor 102.

With reference now to FIG. 2, a damped rotor system 100 includes a rotor blade 104 defining a longitudinal axis A and opposed leading and trailing edges 108 and 110, respectively. Rotor blade 104 includes an inner blade spar 112 which includes a leading edge portion 114 disposed at the leading edge 108 of blade 104, and a trailing edge portion 116 disposed at the trailing edge 110 of rotor blade 104, which reacts to the aerodynamic and inertial loads of the blade 104 and transmits the loads to the hub. The direction of rotation of rotor blade 104 is indicated in FIG. 2 with the large rotation arrow. While rotor blade 104 can be what is called a rigid rotor blade, this refers to the rigid mounting of rotor blade 104 to its rotor head. It is to be understood that rotor blade 104 nonetheless has a degree of flexibility which changes along the length of the blade 104 as measured from the rotor head to a tip of the blade 104. In particular, rotor blade 104 has flexibility in an edgewise direction D defined between the leading and trailing edges 108 and 110, e.g., lead/lag vibration under aerodynamic and inertial loads. While not required in all aspects, the edgewise direction D is shown substantially parallel with the chordwise direction of the blade 104. A structural damping assembly can be augmented to mitigate stability or vibration issues, and in typical applications, less than 1% critical damping is needed to provide suitable damping augmentation.

With reference now to FIG. 3, the structural damping assembly in the damped rotor system 100 includes an eddy current damper 118 with a damper body 120 that is mounted to the blade spar 112. The damper body 120 is mounted chordwise along the X direction. While not required, the damper body 120 is mounted to both to a leading edge portion 114 of the blade spar 112 and to a trailing edge portion 116 of the blade spar 112 opposite the leading edge portion 114, although it is understood that other locations can be used for mounting within the blade 104. The blade spar 112 includes a mounting end, e.g., the end toward the left as oriented in FIG. 2, configured to be mounted to a rotor assembly, and an outboard end opposite the mounting end along the longitudinal axis A, e.g., the tip end on the right as oriented in FIG. 2, wherein the damper body 120 is mounted to the blade spar closer to the outboard end than to the mounting end, e.g., damper body 120 is mounted at the location shown in FIG. 3. However, those skilled in the art will readily appreciate that damper bodies as disclosed herein can readily be mounted in any other suitable location.

The damper body 120 houses a magnetic member 122 movable relative to the damper body 120. The damper body 120 defines a damper axis X along which the magnetic member moves 122 relative to the damper body 120. Damper axis X extends in a direction from the leading edge 108 to the trailing edge 110 for damping edgewise vibrations in the rotor blade, and is substantially parallel with the edgewise direction D shown in FIG. 2. The magnetic member 122 is mounted to the damper body by a pair of springs 124, one on each of opposite sides of the magnetic damper 122, wherein the springs 124 are aligned and compliant in an edgewise direction of the rotor blade, i.e. along damper axis X. A single spring could be used in suitable applications.

The damper body 120 is of an electrically conductive non-ferromagnetic material such that movement of the magnetic member relative to the damper body induces magnetic eddy currents in the damper body for damping vibrations of the rotor blade. For example, the damper body 120 can be of a non-ferrous, conductive material such as aluminum, or any other suitable electrically conductive, non-ferromagnetic material such as copper. The magnetic member 122 includes a non-ferromagnetic non-electrically conductive spool 126 with a rare-earth magnet 128 disposed around the spool 126. For example, the spool 126 can be made of a light weight composite material. The magnetic member 122 includes a lining 130 of bearing material such as Frelon to facilitate relative movement of the magnetic member 122 and the damper body 120.

The damper body 120 includes a tubular wall 132 with the magnetic member 122 inside the tubular wall 132. The tubular wall 122 defines any suitable cross-sectional shape such as square or circular. The magnetic member 122 conforms to the cross-sectional shape of the tubular wall 132. It is also contemplated that the damper body 120 can be configured as a plate, and the magnetic member 122 can be cantilevered proximate the plate in lieu of springs.

The mass of the magnetic member 122, and the spring constants of the springs 124 can be tuned to the desired frequency. The damping is provided by eddy currents induced in the damping body 120 by the movement of magnetic member 122 relative to the body 120 due to vibrations of the blade 104. This converts mechanical motion into heat energy while damping vibrations in the blade 104. Heat can be dissipated from the dampers, e.g., by providing cooling air passively pumped through the rotor blade by centripetal motion or other suitable means such as cooling paths to the outer skin of the blade.

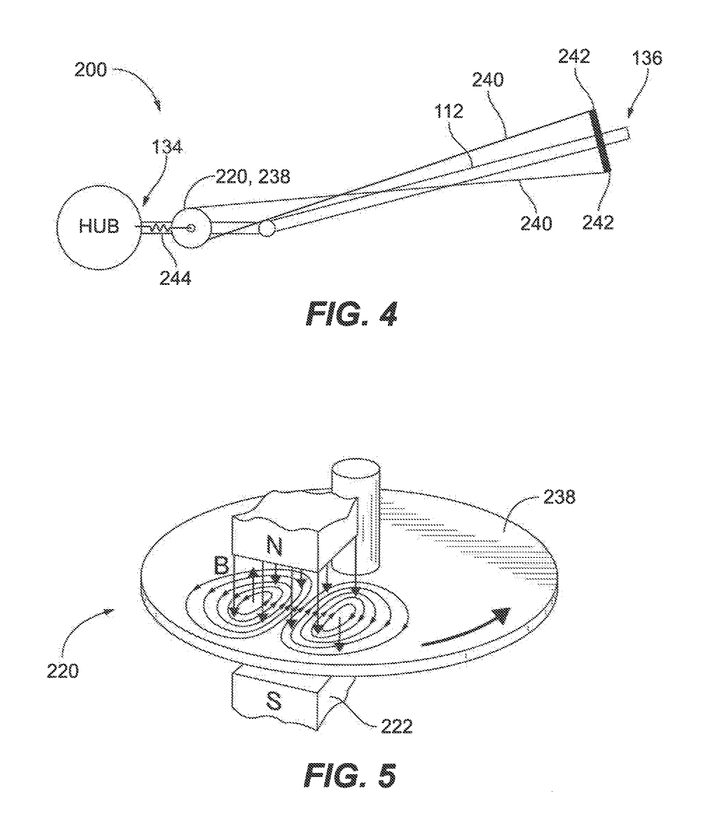

With reference now to FIG. 4, another exemplary embodiment of a structural damping assembly is a blade damping system 200 which utilizes a rotational damper. The blade spar 112 includes a mounting end 134 configured to be mounted to a rotor assembly, e.g., to a hub, and an outboard end 136 opposite the mounting end along the longitudinal axis, e.g., axis A in FIG. 2. The damper body 220 is a rotational eddy current damper mounted to the blade spar closer to the mounting end 134 than to the damper end 136. This eddy current damper includes a pulley wheel 238 and is mounted to the blade spar 112 through a cable 240 wrapped around the pulley wheel 238. Opposed ends 242 of the cable 240 are mounted to respective leading and trailing edge portions of the blade spar, e.g., leading and trailing edge portions 114 and 116 shown in FIG. 2, so the eddy current damper can dampen edgewise vibrations at the outboard end 136 of the blade spar 112. The eddy current damper is mounted to a hub or a hub portion of the rotor blade through a spring member 244 extending axially relative to the longitudinal axis, e.g., axis A in FIG. 2. This arrangement of spar cables translates large tip rotations to the blade root, which would otherwise be small rotations at the blade root. The spring member 244 allows the damper body 220 to move along the axial direction A to account for the cable 240 as the blade 104 flexes as shown in FIG. 4.

With reference now to FIG. 5, damper body 220 includes pulley wheel 238 which is of a non-ferromagnetic, electrically conductive material as described above. A stationary magnetic member 222 induces eddy currents in damper body 220 as damper body rotates relative to magnetic member 222, as indicated schematically in FIG. 5. While described herein in the exemplary context of eddy-current rotational dampers, those skilled in the art will readily appreciate that any other suitable type of rotational dampers or other dampers can be used in place of the eddy-current rotational damper in FIG. 4 without departing from the scope of this disclosure.

Those skilled in the art will readily appreciate that damping systems as described herein can have a primary vibration damping mode in the edgewise direction. However secondary directions of vibration damping such as in the flapping direction can be significant as well, and those skilled in the art will readily appreciate that damping systems as disclosed herein can readily be adapted to dampen any other suitable direction or mode of vibration without departing from the scope of this disclosure. Eddy-current dampers as disclosed herein can provide for passive damping without the need for fluids or fluid-elastic components. Dampers as disclosed herein can be used alone or together with other dampers as needed.

The methods and systems of the present disclosure, as described above and shown in the drawings, provide for rotor damping with superior properties including light weight and improved blade stability in higher thrust maneuvers such as high-G pull-ups and flares to hover. While the apparatus and methods of the subject disclosure have been shown and described with reference to preferred embodiments, including in non-coaxial rotorcraft, in fixed wing aircraft, in propellers or turbine engine blades, wind turbines. Further, it is understood that those skilled in the art will readily appreciate that changes and/or modifications may be made thereto without departing from the scope of the subject disclosure.

What is claimed is:

1. A damped rotor system comprising:
a rotor blade defining a longitudinal axis opposed leading and trailing edges and having a blade spar, wherein the rotor blade has flexibility in an edgewise direction defined between the leading and trailing edges; and
a structural damping assembly comprising an eddy current damper including a damper body mounted to the blade spar, wherein the damper body houses a magnetic member movable relative to the damper body, wherein the damper body is of an electrically conductive non-ferromagnetic material such that movement of the magnetic member relative to the damper body induces magnetic eddy currents in the damper body for damping vibrations of the rotor blade in the edgewise direction.

2. The system as recited in claim 1, wherein the blade spar includes a mounting end configured to be mounted to a rotor assembly, and an outboard end opposite the mounting end along the longitudinal axis, wherein the damper body is mounted to the blade spar closer to the outboard end than to the mounting end.

3. The system as recited in claim 1, wherein the damper body defines a damper axis along which the magnetic member moves relative to the damper body, wherein the damper axis extends in a direction from the leading edge to the trailing edge for damping edgewise vibrations in the rotor blade.

4. The system as recited in claim 1, wherein the damper body is mounted to a leading edge portion of the blade spar and to a trailing edge portion of the blade spar opposite the leading edge portion.

5. The system as recited in claim 1, wherein the magnetic member is mounted to the damper body by a spring complaint in an edgewise direction of the rotor blade.

6. The system as recited in claim 1, wherein the magnetic member is mounted to the damper body by a pair of springs, one on each of opposite sides of the magnetic damper, wherein the springs are aligned and compliant in an edgewise direction of the rotor blade.

7. The system as recited in claim 1, wherein the magnetic member includes a non-ferromagnetic non-electrically conductive spool with a rare-earth magnet disposed around the spool.

8. The system as recited in claim 1, wherein the magnetic member includes a lining of a bearing material to facilitate relative movement of the magnetic member and the damper body.

9. The system as recited in claim 1, wherein the damper body is of aluminum.

10. The system as recited in claim 1, wherein the damper body includes a tubular wall with the magnetic member inside the tubular wall, wherein the tubular wall defines a cross-sectional shape of at least one of square or circular.

11. The system as recited in claim 10, wherein the magnetic member conforms to the cross-sectional shape of the tubular wall.

12. The system as recited in claim 1, wherein the blade spar includes a mounting end configured to be mounted to a rotor assembly, and an outboard end opposite the mounting end along the longitudinal axis, wherein the damper body is a rotational eddy current damper mounted to the blade spar closer to the mounting end than to the damper end.

13. The system as recited in claim 12, wherein the eddy current damper includes a pulley wheel and is mounted to the blade spar through a cable wrapped around the pulley wheel, wherein opposed ends of the cable are mounted to respective leading and trailing edge portions of the blade spar so the eddy current damper can dampen edgewise vibrations at the outboard end of the blade spar.

14. The system as recited in claim 12, wherein the eddy current damper is mounted to a hub or a hub portion of the rotor blade through a spring member extending axially relative to the longitudinal axis.

15. An aircraft comprising:
a rotor assembly which rotates about an axis; and
the damped rotor system as recited in claim 1, wherein the rotor blade is mounted to the rotor assembly.
